(19) United States
(12) Patent Application Publication
(10) Pub. No.: US 2009/0002762 A1
(43) Pub. Date: Jan. 1, 2009

(54) Image processing apparatus, computer readable recording medium stored with image processing program, and image processing method

(75) Inventors: Shigeru Sakamoto, Sagamihara-shi (JP); Isao Yamashita, Kawasaki-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES,INC.

(21) Appl. No.: 12/009,934

(22) Filed: Jan. 23, 2008

(30) Foreign Application Priority Data
Jun. 28, 2007 (JP) 2007-171175

(51) Int. Cl. G06F 15/00; G06K 1/00; G06K 9/36

(52) U.S. Cl. 358/1.16; 358/1.18; 382/232; 358/1.17

(57) ABSTRACT

An image processing apparatus applies a compression process to each of a plurality of areas within a page independently on a specified page of image data consisting of a plurality of pages, and stores thus obtained compressed image data in a storage unit. Next, the image processing apparatus identifies an area as a unique area if the area has different contents when a plurality of areas within the specified page are compared with a plurality of areas within a page different from the specified page respectively between the corresponding areas. The image processing apparatus corrects unique compressed image data among compressed image data of the specified page stored in the storage unit that corresponds to the unique area to be identical to corrected unique compressed image data obtained by compressing the unique area of a page different from the specified page, and outputs the corrected compressed image data to a printer.

### CROSS-REFERENCE TO RELATED APPLICATION

This application is based on Japanese Patent Application No. 2007-171175, filed on Jun. 28, 2007, the contents of which are incorporated herein by reference.

### BACKGROUND

1. Technical Field

The present invention relates to an image processing apparatus, a computer readable recording medium stored with an image processing program, and an image processing method. The present invention particularly relates to an image processing apparatus, an image processing method, and an image processing program, which provide a more efficient process of outputting image data to a printing unit.

2. Description of Related Art

It takes an enormous amount of time to reproduce image data in a bitmap-format (hereinafter called also “raster image”) used in printing in case of mass-printing such things as direct mail, labels and business forms where pictures and photographs are used abundantly.

As one solution to this, a system called “variable data printing” has been proposed. The variable data printing method means a printing method in which the output contents of each page can be partially replaced depending on the needs. In the variable data printing system, the printing data contains reusable objects that can be used repeatedly and non-reusable objects that are used only once as minimum composition units. Whether an object is a reusable object or a non-reusable object is also clearly differentiated in the layout information of the printing data. The layout information also describes how objects are laid out within a page. A printing apparatus that supports a variable data printing language caches a raster image formed by applying RIP (Raster Image Process) to a reusable object in the printing data and reuses this cached raster image to reduce the time needed for RIP in order to improve its performance.

Furthermore, there has been proposed a printer controller that extracts the reusable data of each object to be used on multiple pages within a file and prepares form data by synthesizing the extracted reusable data. See Unexamined Japanese Patent Publication No. 2006-237825.

In this case, the print controller can prepare the raster image of a page by synthesizing the prepared form data and the data of each object that is not contained in the particular form data.

However, the technology described in the cited document is a technology of reducing the time required for preparing the raster image of each page and does not disclose a more efficient process of transferring the prepared raster image to a printer engine for printing.

A high resolution color image after the RIP can sometimes have an enormous data size (for example, as large as 130 MByte per page for CMYK 8 bit/600 dpi/A4 size). In order to avoid the image data transfer time from becoming a bottle neck in the printing process time, the raster image after the RIP is normally transferred to the printer engine after a compression process. However, such a compression process is applied to the entire page of the raster image, it takes a substantial time for the compression process of each page, so that reduction of the compression processing time is required from the standpoint of realizing a further speedier printing.

To solve at least one of the abovementioned problems, there is provided an image processing apparatus, which reflects one aspect of the present invention. The image processing apparatus comprises a compression unit that applies a compression process to each of a plurality of areas within a page independently on a specified page of image data consisting of a plurality of pages; a storage unit that stores the compressed image data of said specified page obtained by the compression by said compression unit; an identifying unit that identifies an area as a unique area if the area has different contents when a plurality of areas within said specified page are compared with a plurality of areas within a page different from said specified page respectively between the corresponding areas; a correction unit that corrects unique compressed image data among compressed image data of said specified page stored in said storage unit that corresponds to said unique area to be identical to corrected unique compressed image data obtained by compressing said unique area of a page different from said specified page; and an output unit that outputs the compressed image data corrected by said correction unit.

It is preferable that each page of said image data is obtained by converting each page of printing data inputted into said image processing apparatus into data of a bitmap format used for printing; and said identification unit identifies said unique area based on layout information contained in said printing data that indicates which object to be laid out where in the page.

It is preferable that the specified page of said image data is obtained by converting said specified page of printing data inputted into said image processing apparatus into data of a bitmap format used for printing; and said identification unit identifies said unique area based on layout information contained in said printing data that indicates which object to be laid out where in the page; and said corrected unique compressed image data is the image data obtained by applying the compression process to the image data, which is obtained by overwriting the restored image data of said unique compressed image data with the object image data obtained by converting the objects corresponding to said unique areas of said printing data into data of a bitmap format used for printing.

It is preferable that said identifying unit divides said image data into a plurality of equally divided area within a page, and identifies an area as a unique area if the area has different contents when a plurality of areas divided within said specified page are compared with a plurality of areas of a page different from said specified page respectively between the corresponding areas.

It is preferable that said corresponding areas are compared based on the data obtained by digitizing each area.

It is preferable that said compression process is a fixed length data compression process.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is an overall constitutional diagram of the printing system according to a first embodiment of the invention.

FIG. 2 is a block diagram showing the general constitution of a client terminal.

FIG. 3 is a block diagram showing the general constitution of a printer controller.

FIG. 4 is a diagram for describing a Raster image generating part, and a printing data analyzing unit.

FIG. 5 is a diagram for describing the Raster image generating part, an updating block information recording unit, and a compressed image storage unit.

FIG. 6 is a diagram for describing a printing data storage unit.

FIG. 7 is a block diagram showing the general constitution of a printer.

FIG. 8 is a schematic drawing for describing image data of 20×20 pixels.

FIG. 9 is a schematic drawing for describing the compression for each block.

FIG. 10 is a drawing schematically showing the image data of FIG. 9 after the compression.

FIG. 11 is a flowchart showing the process sequence on the printer controller.

FIG. 12 is a flowchart showing the process sequence of preparing and outputting the compressed image.

FIG. 13 is a diagram showing an example of page layout.

FIG. 14 is a diagram showing a page layout sectored by blocks.

FIG. 15 is a diagram for describing updated blocks corresponding to updated fields.

FIG. 16 is a diagram for showing a method of correcting a compressed image based on the updated block information.

FIG. 17 is a flowchart indicating the process sequence of preparing and outputting the compressed image in a second embodiment.

FIG. 18 is an example of a method correcting the compressed image in the second embodiment.

FIG. 19 is a flowchart indicating the process sequence of preparing and outputting the compressed image in a third embodiment.

FIG. 20 is a drawing to show an example RGB raster image generated with a low degree of resolution.

FIG. 21 is a drawing to show an example raster image divided into M×N areas.

FIG. 22 shows an example table of hash values of various areas in the RGB raster image of a single page.

FIG. 23 is a table showing the result of discrimination between the common areas and the unique areas.

FIG. 24 is a diagram showing an example of generated low resolution RGB raster image in case when the printing data having a front page and a back page is to be printed on both sides.

### DETAILED DESCRIPTION

The embodiment of this invention will be described below with reference to the accompanying drawings.

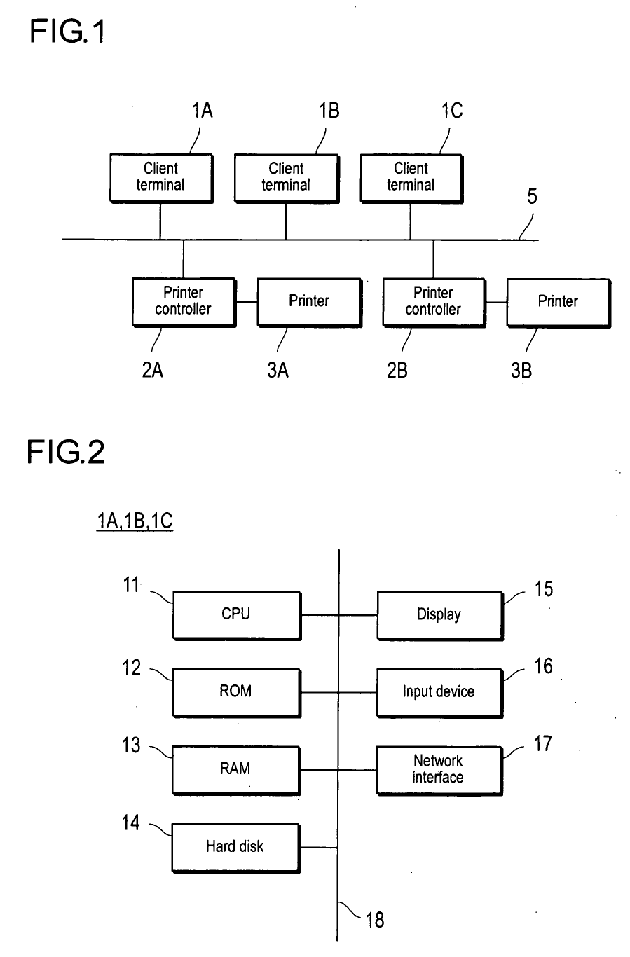

FIG. 1 is an overall constitutional diagram of the printing system according to the first embodiment of the invention.

The printing system is equipped with client terminals 1A, 1B, and 1C; printer controllers 2A and 2B; and printers 3A and 3B.

The client terminals 1A, 1B, and 1C and the printer controllers 2A and 2B are interconnected with each other via a network 5 to be communicable with each other. The network 5 can be a LAN connecting computers and network equipment according to standards such as Ethernet®, Token Ring, and FDDI, or a WAN that consists of several LANs connected by a dedicated line. The printer controllers 2A and 2B and the printers 3A and 3B are connected respectively via dedicated interface buses such as IEEE 1394 serial buses. However, a printer controller and a printer can be connected via the network 5 as well. The types and the number of equipment to be connected to the network 5 are not limited to those shown in FIG. 1.

Next, constitution of each device mentioned above will be described below, but the description of a function common to multiple devices will be made only once when it first appears and will not be repeated afterwards in order to avoid duplicate descriptions.

FIG. 2 is a block diagram showing the general constitution of the client terminals 1A, 1B, and 1C. The client terminals 1A, 1B, and 1C are typically PCs (personal computers). Since the client terminals 1A, 1B, and 1C have identical constitutions with each other, the client terminal 1A shall be used to represent all of them in the following description.

The client terminal 1A contains a CPU 11, a ROM 12, a RAM 13, a hard disk 14, a display 15, an input device 16 and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

The hard disk 14 has an application program for generating document files and a printer driver for converting document files into printing data understood by the printer controllers installed.

The display 15 is typically a LCD or a CRT and displays various kinds of information. The input device 16 includes a pointing device such as a mouse, a keyboard, and others, and is used for executing various kinds of inputs. The network interface 17 is typically a LAN card and is used for communicating with external equipment via the network 5.

The client terminal 1A prepares printing data and transmits it to a printer controller. The client terminal 1A is also capable of monitoring the processing conditions at the printer controllers 2A and 2B and displaying page prepared in the printer controller 2A and 2B.

The printing data in this embodiment is preferably a file of a format that follows the PPML (Personalized Print Markup Language). The printing data here is a file consisting of a layout file having the layout information of the objects of each page and a data file having a group of data per each object combined into one. The data file contains reusable objects and non-reusable objects. A reusable object is an object that can be used on one page or repetitively on multiple pages, while a non-reusable object is an object that can be used only once. The layout information of the layout file contains information by object type that shows whether each object is a reusable object or non-reusable object, and information that shows where each object is placed in each page.

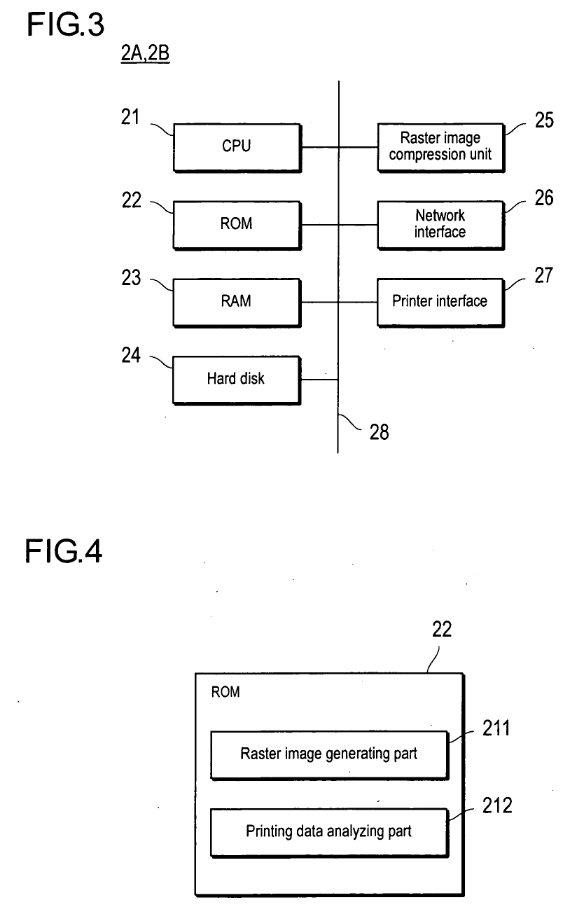

FIG. 3 is a block diagram showing the general constitution of the printer controllers 2A and 2B. Since the printer controllers 2A and 2B have identical constitutions, the printer controller 2A shall be used to represent both in the following description.

The printer controller 2A contains a CPU 21, a ROM 22, a RAM 23, a hard disk 24, a raster image compression unit 25, a network interface 26, and a printer interface 27, all of which are interconnected via a bus 28 for exchanging signals.

The raster image compression unit 25 applies the compression process to each area separately within a page of the raster image. Although the Raster image generating part 25 is built as hardware in the present embodiment, it can also be constituted in such a way that a memory unit such as the ROM 22 stores a program that correspond to it and that the CPU 21 executes the program in order to implement its function.

The printer interface 27 is an interface for communicating with the printer 3A. The printer interface 27 is used for transferring the compressed image of one page portion.

As shown in FIG. 4, the ROM 22 provides specific areas for storing programs corresponding to a raster image generating part 211 and a printing data analyzing part 212 respectively. The Raster image generating part 211 executes RIP (Raster Image Processing) in order to convert the received printing data into image data in a bitmap format. In other words, the Raster image generating part 211 converts the object of the data file contained in the printing data into raster image, i.e., image data of the bit map format to be used by the printer 3A for printing. The printing data analyzing part 212 analyzes the received printing data and identifies the unique areas having contents different from those of the standard page and outputs them as updated block information. For example, they are clients' names and addresses in case of a direct mail. The functions of the raster image generating part 211 and the printing data analyzing part 212 are implemented as the CPU 21 executes their respective programs.

As shown in FIG. 5, the RAM 23 provides specific areas for a form image storage part 231, an updated block information storage part 232, and a compressed image storage part 233 for their exclusive uses respectively. The raster image storage part 231 stores generated raster images. The updated block information storage part 232 stores updated block information generated. The updated block information is erased from the RAM 23 immediately after it is used by the raster image compression part 25. The compressed image storage part 233 stores generated or corrected compressed images. The compressed images are image data produced by compressing raster image of one page portion.

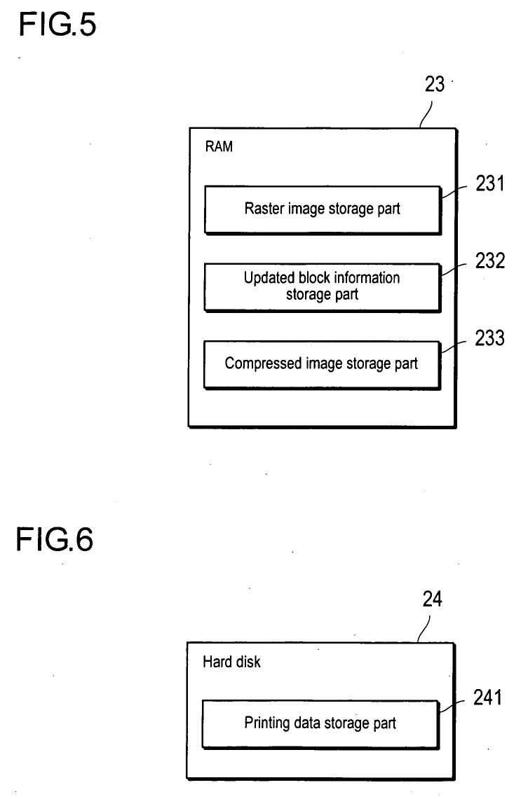

As shown in FIG. 6, the hard disk 24 has an area for a printing data storage part 241. The printing data storage part 241 stores the received printing data.

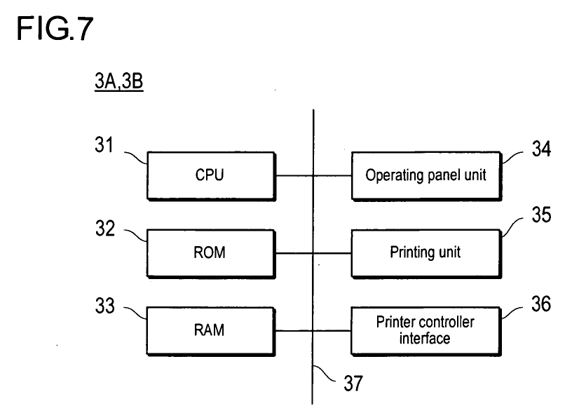

FIG. 7 is a block diagram showing the general constitution of a printer 3A. Since the printers 3A and 3B have identical constitutions, the printer 3A shall be used to represent both in the following description.

The printer 3A has a CPU 31, a ROM 32, a RAM 33, an operating panel unit 34, a printing unit 35, and a print controller interface 36, all of which are interconnected with each other via a bus 37 for exchanging signals.

The operating panel unit 34 is used for various information displays and for entering various instructions. The printing unit 35 prints image data on recording media such as paper using a known imaging process such as the electronic photographing process including such processes as electrical charging, exposure, developing, transferring and fixing. The printer controller interface 36 is an interface for communicating with the printer controller 2A.

The client terminals 1A, 1B, and 1C; the printer controllers 2A and 2B; and the printers 3A and 3b can contain components other than those components mentioned above, or do not have to contain all of the components mentioned above.

The data compression process used in this embodiment will be described below.

The data compression process consists of fixed length data compression and variable data compression. The fixed length data compression means the data compression process in which the compression ratio after compression is fixed. The characteristics of the fixed length data compression include compression of the data by block unit (targeting a specific quantity of data).

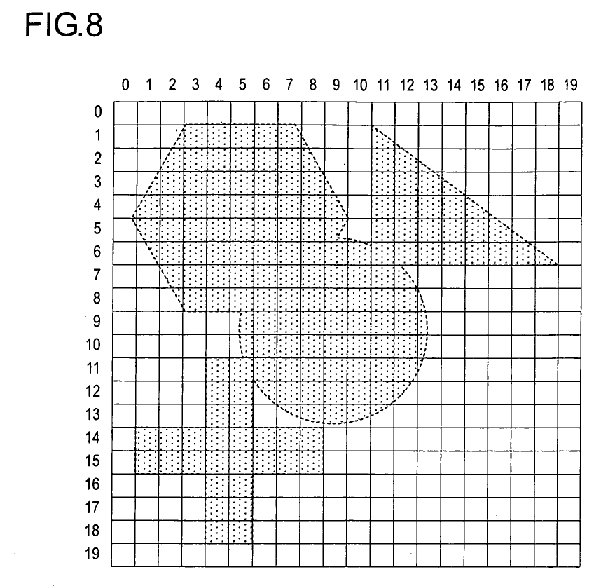

Let us assume that image data of 20×20 pixels having a data quantity of 1 Byte per pixel exists as shown in FIG. 8. Let us describe a case of applying fixed length data compression to the image data shown in FIG. 8.

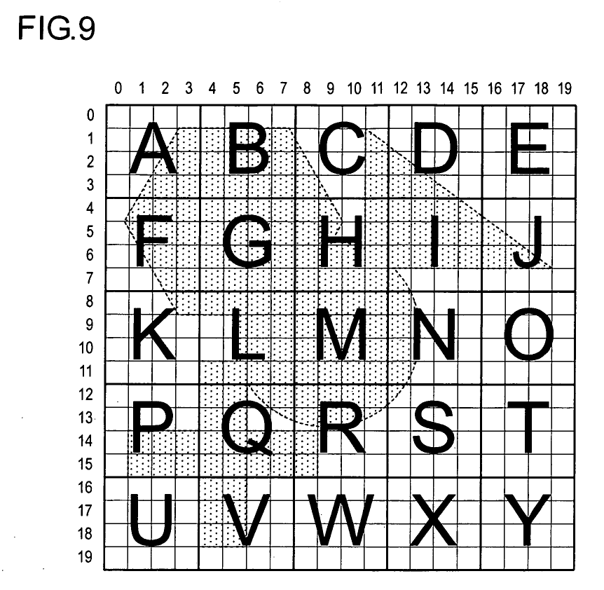

FIG. 9 is a diagram for schematically showing that GBTC (Generalized Block Truncation Coding), which is known as a typical fixed length image data compression technology, is essentially a compression by block unit.

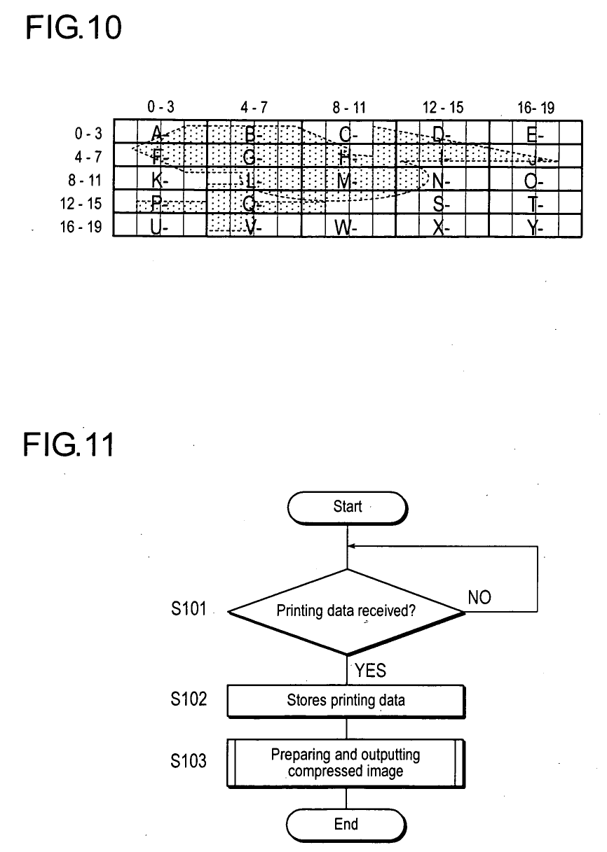

In the GBTC compression, a block of 4×4 pixels (16 byte) is compressed independent of adjacent blocks. When the image data of FIG. 8 is divided into blocks of 4×4 pixels, it is divided into 25 blocks of A through Y as shown in FIG. 9. In the GBTC compression, each of these A through Y blocks is compressed into a block of 6 bytes. FIG. 10 is a drawing schematically showing the image data of FIG. 9 after the compression.

As one looks at the layout of each block of A˜Y in FIG. 9 and of A-˜Y- in FIG. 10, it becomes visible that the layout constitution of each block is the same between FIG. 9 and FIG. 10. Each block of A-˜Y- in FIG. 10 is compressed independently by block unit, the compressed image generated by block unit can be reused. Therefore, it is preferable to use the fixed length data compression from the standpoint of the process efficiency in the present embodiment. The type of compression process that can be used, however, is arbitrary so long as the compressed image generated by block unit can be reused.

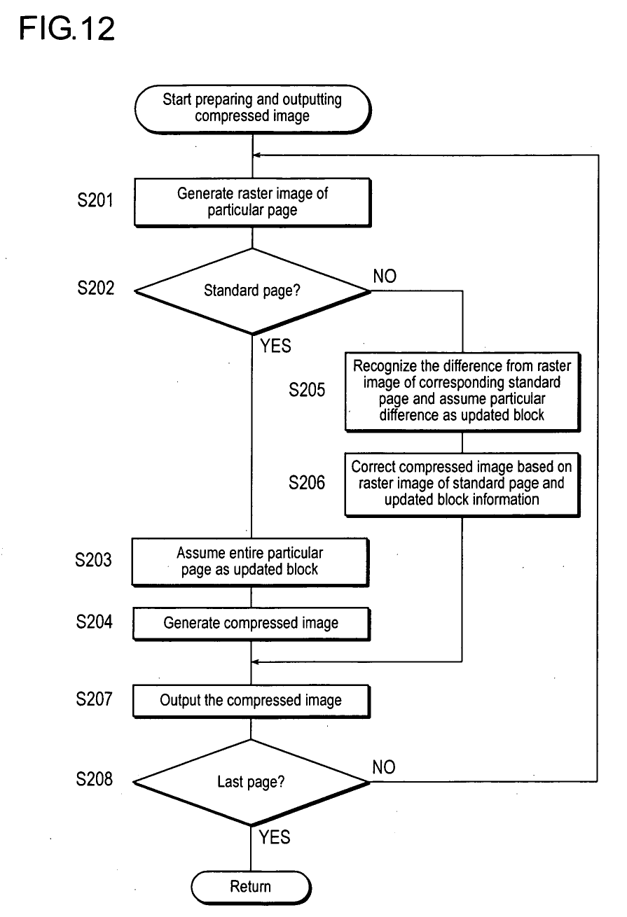

Next, the image recording process in the printer controller 2A will be described below referring to FIG. 11 and FIG. 12. The algorithm shown in the flowcharts of FIG. 11 and FIG. 12 is stored as a program in a memory unit such as a ROM 22 of printer controller 2A and executed by CPU 21.

First, the user prepares a printing data for executing variable print using the application software program installed in the client terminal 1A.

The printer controller 2A stands by until a printing data is received from the client terminal 1A (S101: No).

When the printing data is received (S101: Yes), the printer controller 2A stores the received printing data in the printing data storage unit 241 of the hard disk 24 (S102). However, the received printing data can be stored in the remote database server or a common file system.

As mentioned before, printing data contains a layout file and a data file. A data file used here can be a file described in a PDL (Page Description Language) such as PS (PostScript®), PDF (Portable Document Format), and EPS (Encapsulated PostScript). However, a data file can also consist of other type of data such as RIP-processed data and vector data.

Next, the preparing and outputting of the compressed image are executed (S103). At this stage, the compressed image for each page is generated and outputted to the printer 3A.

Next, the generation and outputting of the compressed image will be described with reference to FIG. 12.

First, the printing data stored in the hard disk 24 is transferred to the raster image generating part 211 where one page portion of the raster image is generated (S201).

Next, a judgment is made as to whether the generated raster image is that of the standard page or not (S202). The standard page here means the smallest page of a group classified based on the similarity among the pages. In case of direct mail, for example, in which only the customer's name and address portions vary, there is only one group so that the standard page is the top page (first page). On the other hand, in case of tickets and the like where the printing data having a front page and a rear page to be printed on both sides, there are two groups so that the standard pages are the top page (first page) and the second page. A standard page can be recognized by analyzing the layout information of the printing data.

If the generated raster image is a standard page (S202: Yes), the printing data analyzing part 212 generates the updating block information, of which the entire particular page is the updating block (S203).

Next, a compression process is applied to the raster image of the standard page to generate a compressed image (S204), and the program proceeds to step S207. The compressed image thus generated is remembered in the compressed image storage part 233. The compressed images as many as the number of the standard page will be stored individually.

On the other hand, if the generated raster image is not the standard page (S202: No), the printing data analyzing part 212 recognizes based on the layout information of the printing data the difference between the raster image of the page in question and that of the corresponding standard page as the unique area, and generates the updated block information using said difference as the updating block (S205).

Next, the compressed image stored in the compressed image storage part 233 is corrected based on the corresponding standard page's raster image and the updated block information (S206). More specifically, the unique area corresponding to the part to be updated in the compressed image is cut out from the raster image generated in step S201 based on the updated block information, and applied with the compression process to generate a corrected unique compressed image. A unique compressed image corresponding to the unique area within the compressed image is corrected to be identical to the corrected unique compressed image. The correction (update) of the unique compressed image to form the corrected unique compressed image can be done by processes such as overwriting, replacement, etc. The areas sharing the same common contents among a plurality of pages of the compressed images are updated only in the areas that need to be updated.

In step S207, the compressed image generated in step S204 or the compressed image corrected in step S206 are outputted to the printer 3A. The printer 3A restores (expands) and prints the compressed image received from the printer controller 2A on a recording medium such as a sheet of paper.

In step S208, a judgment is made as to whether the page currently being processed is the final page or not. If it is judged that it is no the final page (S208: No), the program returns to step S201. If it is judged that it is the final page (S208: Yes), the program returns to the flowchart of FIG. 11.

Next, the generation of the updated block information (S203, S205) will be described in more detail.

The updated block information is the information used for designating the blocks to be updated within the compressed image stored in the compressed image storage part 233. The printing data is prepared in a variable language in the present embodiment, and the printing data contains the layout information. The layout information is the information that designates how the reusable objects and the non-reusable objects are to be laid out on a page. The layout information contains the object (or the name with which it can be designated) to be laid out, the size (width and height) of the object to be laid out, and the coordinates (X and Y coordinates) for laying out the object.

The updated block information is generated based on this layout information.

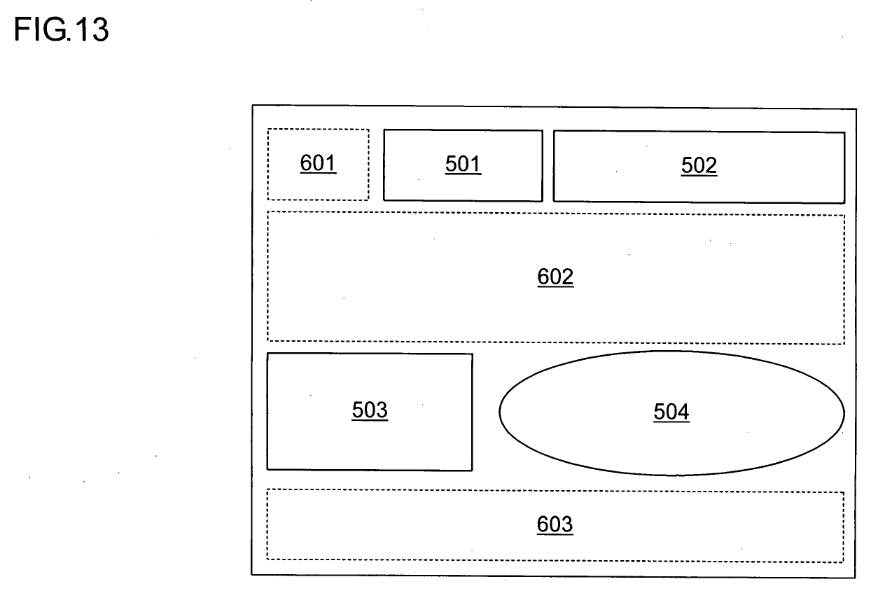

FIG. 13 shows an example of page layout.

In this drawing, the updated fields 501˜504 are the fields to be updated in each page (indicated by rectangular or elliptical shape of solid lines). The reusable fields 601˜603 are common fields on all pages (indicated y rectangular shapes of broken lines). Each field consists of at least one object. The layout information within the printing data is compared by page unit and the fields that are different from those on the standard page are judged to be updated fields and the fields that are the same as those of the standard page are judged to be reusable fields.

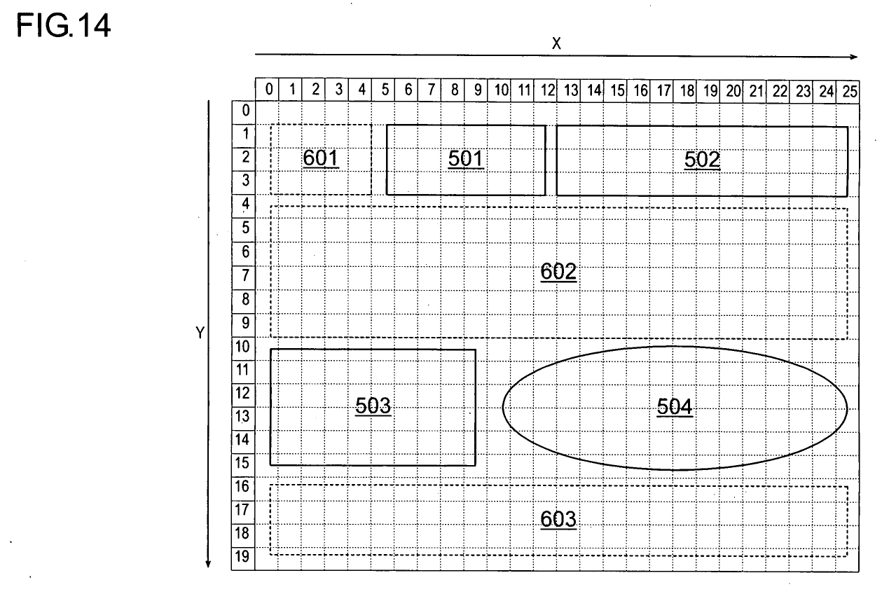

FIG. 14 is a diagram showing a page layout sectored by blocks.

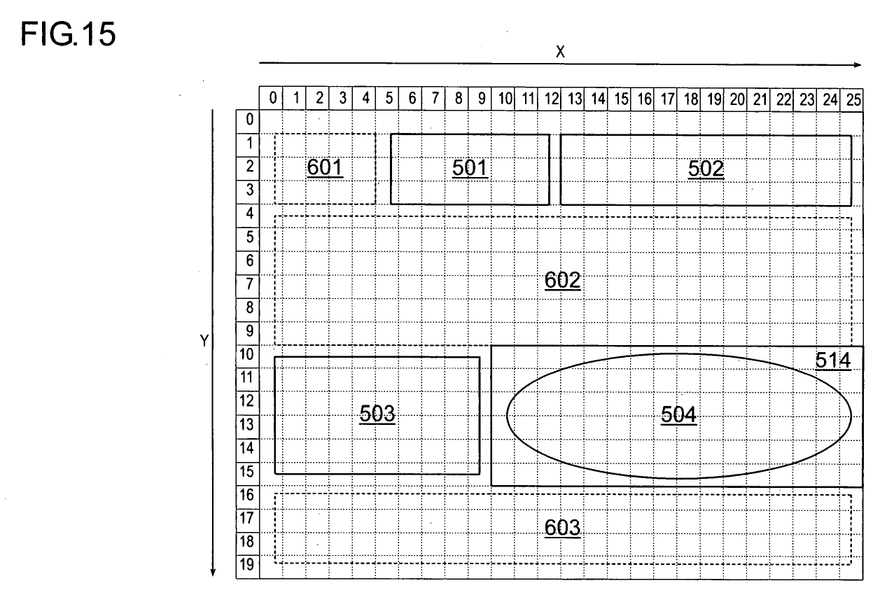

As shown in FIG. 14, the updated fields exist with no relation to the block boundaries. The updated block information is generated by designating the blocks that contain the updated fields as rectangular areas. Therefore, if an elliptical updated field exists such as the updated field 504 shown in FIG. 14, the rectangular area that surrounds the entire blocks that contain the updated field 504 with the block boundaries is considered an updated block. Consequently, the updated block that corresponds to the updated field 504 is an area shown by the code 514 in FIG. 15.

Let the X-axis direction byte count and the Y-axis direction byte count of a single block which is an object of compression be called nx and ny respectively, the starting coordinates (in the pixel unit) of the starting coordinate in the X-axis direction and the starting coordinate in the Y-axis direction in the update field to be called mx and my respectively, and the ending coordinates (in the pixel unit) of the ending coordinate in the X-axis direction and the ending coordinate (in the pixel unit) in the Y-axis direction in the update field to be called px and py respectively, the starting coordinate in the X-direction and the starting coordinate in the Y-direction of the updated block Mx and My respectively as well as the ending coordinate in the X-direction and the ending coordinate in the Y-direction of the updated block Px and Py respectively are calculated by the following formulae. In FIG. 14, the origin of the coordinate system is located at the top left corner.

Mx=RD(mx/nx)×nx

My=RD(my/ny)×ny

Px=RU(px/nx)×nx

Py=RU(py/ny)×ny

where “RD” is a function that rounds down and “RU” is a function that rounds up.

The updated block information is shown by the coordinates expressed in the pixel unit on the raster image calculated based on the above formulae

Next, the process of correcting the compressed image (S206) based on the updated block information will be described in more detail.

In order for the printing data described in a variable language to be more effective, it is preferable that all pages are of the same size and in the same layout, and it is also normal as well, so that it is assumed that all pages are of the same size.

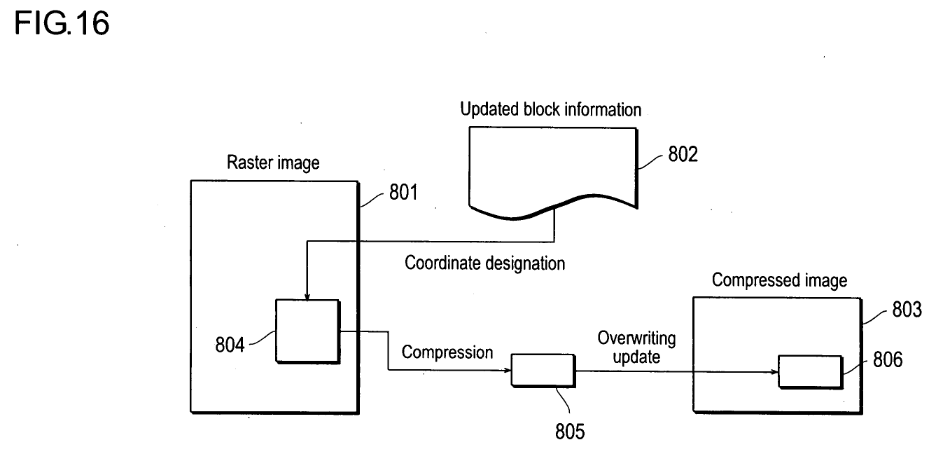

FIG. 16 is a diagram for showing a method of correcting a compressed image based on the updated block information.

A raster image 801 generated by the raster image generating part 211 is one page portion of the image data. A compressed image 803 is the result of compressing the one page portion of the image data. In order to correct the compressed image 803, the block on the raster image 801 indicated by the updated block information 802 is referenced. Such a block is a unique area 804 that corresponds to the area to be updated. Next, a corrected unique compressed image 805 is generated as the referenced block is compressed. Moreover, the corrected unique compressed image 805 is written over the corresponding part of the compressed image 803. In other words, a unique compressed image 806 corresponding to the unique area 804 within the compressed image 803 is corrected to be identical to the corrected unique compressed image 805.

The block to be updated on the compressed image 803 is obtained as follows based on the updated block information 802 indicated by the pixel coordinates on the raster image 801.

The starting coordinate in the X-axis direction and the starting coordinate in the Y-axis direction of the block to be updated on the compressed image 803 Bsx and Bsy respectively as well as the ending coordinate in the X-axis direction of the block to be updated on the compressed image 803 and the ending coordinate in the Y-axis direction of the same Bex and Bey respectively are calculated based on the following formulae in terms of the block unit coordinate system:

Bsx=Mx/nx

Bsy=My/y

Bex=Px/nx

Bey=Py/ny

where nx and ny are the X-axis byte count and the Y-axis byte count of a single block to be the object of compression respectively, Mx and MY are the starting coordinate (in the pixel unit) in the X-direction and the starting coordinate (in the pixel unit) in the Y-direction of the updated block, and Px and Py are the ending coordinate (in the pixel unit) in the X-direction and the ending coordinate (in the pixel unit) in the Y-direction of the updated block.

As can be seen from the above, the locations of the blocks to be updated on the compressed image 803 can be expressed by the coordinates on the compressed image expressed in the block unit on the compressed image 803 calculated according to the above formulae.

As described above, the printer controller 2A of the present embodiment applies the compression process to each of a plurality of areas within a page independently on the specified page of the image data consisting of a plurality of pages, and stores thus obtained compressed image 803 in the storage unit. Next, the printer controller 2A identifies an area as the unique area 804 if the area has different contents when a plurality of areas within the specified page are compared with a plurality of areas within a page different from the specified page respectively between the corresponding areas. The printer controller 2A corrects the unique compressed image 806 among compressed image 803 of the specified page stored in the storage unit that corresponds to said unique area 804 to be identical to the corrected unique compressed image 805 obtained by applying the compression process to the unique area 804 of a page different from said specified page, and outputs the corrected image to the printer 3A.

The areas sharing the same common contents among a plurality of pages of the compressed images are updated only in the areas that need to be updated. Thus, the time required for the process of compressing the image data consisting of a plurality of pages can be reduced and the printing process performance can be improved.

Next, a printing system according to the second embodiment of the invention will be described below. Since the hardware constitution is identical to that of the printing system of the first embodiment, the description is omitted. The following description of the printing system according to the second embodiment therefore focuses on those points which are different from the first embodiment.

In the first embodiment, the entire page portion of the raster image of a single page is generated by the raster image generating part 211. This makes it possible to overwrite, for example, the compressed image with the unique area cut out from the generated raster image and compressed in updating the compressed image. In the meanwhile, the performance of an image forming device such as a printer that supports the variable language can be improved by reducing the RIP time by caching the raster image of an object generated by applying RIP on a reusable object and reusing the cached raster image. As such, the second embodiment is to provide a method of correcting the compressed image using the raster image of the reusable object designated according to the layout information contained in the printing data.

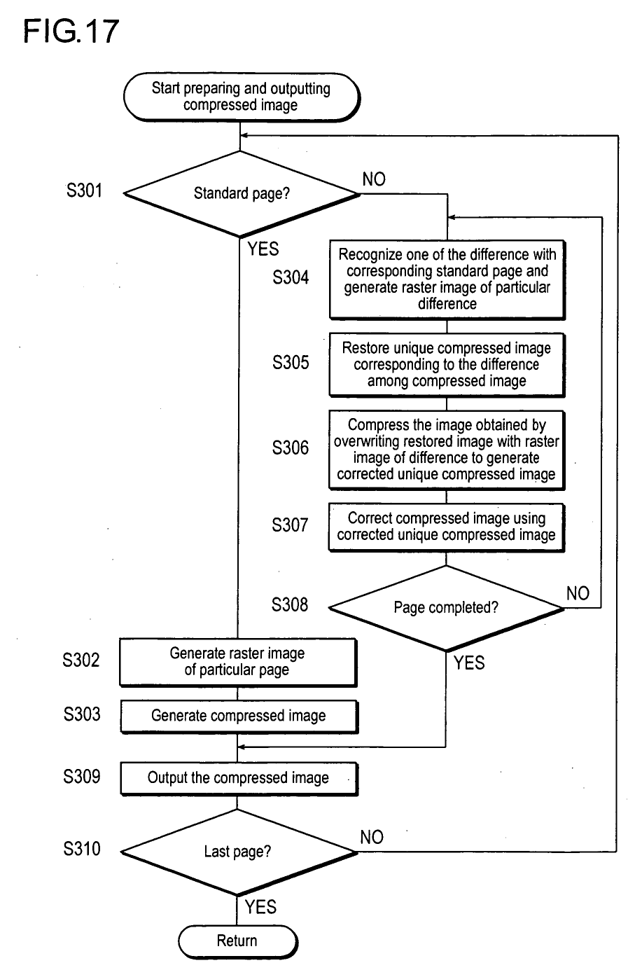

FIG. 17 is a flowchart indicating the process sequence of preparing and outputting the compressed image in a second embodiment.

First, a judgment is made as to whether the page selected to be processes is a standard page or not (S301). The standard page here means the smallest page of a group classified based on the similarity among the pages. Such a standard page can be recognized by analyzing the layout information of the printing data.

If the page to be processed is a standard page (S301: Yes), one page portion of the particular one page portion of the raster image is generated (S302).

Next, a compression process is applied to the raster image of the standard page to generate a compressed image (S303), and the program proceeds to step S309. The compressed image thus generated is remembered in the compressed image storage part 233. The compressed images as many as the number of the standard page will be stored individually.

On the other hand, if the generated raster image is not the standard page (S301: No), the printing data analyzing part 212 recognizes one of the differences between the raster image of the page in question and that of the standard page as the unique area based on the layout information of the print data, and generates a raster image of the difference (S304).

Next, the unique compressed image is restored among the compressed images stored in the compressed image storage part 233 (S305).

Next, the corrected unique compressed image is generated by compressing the image obtained by overwriting the restored image with the differential raster image (S306).

The compressed image is then corrected using the corrected unique compressed image (S307). In other words, the unique compressed image corresponding to the unique area within the compressed image is corrected to become the corrected unique compressed image.

In the step S308, a judgment is made as to whether the compressed page has been completed or not. In other words, it is judged whether all the differences between the page to be processed and the corresponding standard page should be corrected or not.

In step S309, the compressed image generated in step S303 or the compressed image corrected and completed in step S307 is outputted to the printer 3A. The printer 3A restores (expands) and prints the compressed image received from the printer controller 2A on a recording medium such as a sheet of paper.

In step S310, a judgment is made as to whether the page currently being processed is the final page or not. If it is judged that it is no the final page (S310: No), the program returns to step S301. If it is judged that it is the final page (S310: Yes), the program returns to the flowchart of FIG. 11.

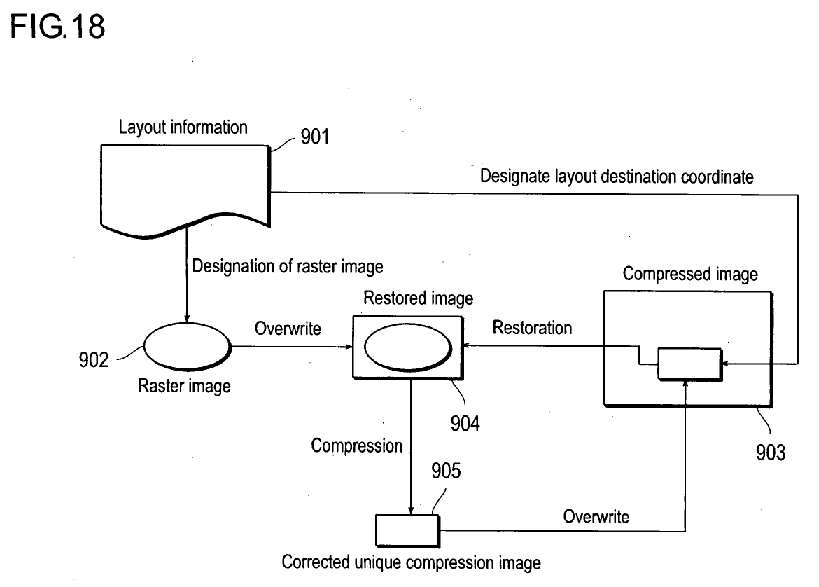

Next, the correction of the compressed image in the second embodiment will be described in more detail. FIG. 18 is an example of a method correcting the compressed image in the second embodiment.

First, a raster image (object image) 902 to be laid out on a compressed image 903 is designated in accordance with a layout information 901, and the layout destination coordinate of the raster image 902 on the compressed image 903 is designated. Since the layout destination coordinate is the coordinate in the pixel unit on the raster image of the entire page, the layout destination coordinate shall first be converted into the coordinate in the block unit on the compressed image.

The starting and ending coordinates in the X-axis direction Bsx and Bex respectively as well as the starting and ending coordinates in the Y-axis direction Bsy and Bey of the layout destination of the raster image 902 on the compressed image 903 in terms of the block unit coordinate system are calculated by the following formulae:

Bsx=RD(sx/nx)

Bex=RU((sx+w)/nx)

Bsy=RD(sy/ny)

Bey=RU((sy+h)/ny)

where nx and ny are the X-axis byte count and the Y-axis byte count of a single block to be the object of compression respectively, sx and sy are the starting coordinate (in the pixel unit) in the X-axis direction and the starting coordinate (in the pixel unit) in the Y-direction of the raster image 902 on the raster image of the entire page, and w and h are the width and height (in the pixel unit) of the raster image 902. Also, “RD” is a function that rounds down and “RU” is a function that rounds up.

The block indicated by the layout destination coordinate expressed in the block unit on the compressed image is then restored, and a restored image 904 is generated.

Moreover, the restored image 904 is overwritten with the raster image 902.

Rsx and Rsy that represents the starting coordinate (in the pixel unit) in the X-axis direction and the starting coordinate (in the pixel unit) in the Y-axis direction respectively where the restored image 904 is to be overwritten with the raster image 902 are calculated by the following formulae:

Rsx=sx % nx

Rsy=sy % ny

where “A % B” means the remainder left when A is divided by B.

A corrected unique compressed image 905 is generated when the restored image 904 is overwritten with the raster image 902, and the overwritten image is compressed again.

Lastly, the corrected unique compressed image 905 is overwritten over the compressed image at the starting and ending positions in the X-axis direction, Bsx and Bex, as well as the starting and ending positions in the Y-axis direction, Bsy and Bey all expressed in the block unit.

As can be seen in the above, in the second embodiment, the corrected unique compressed image is generated by applying the compression process to the image obtained by overwriting the object image, which is obtained by applying the rasterizing process to the object corresponding to the unique area, over the restored image, which is obtained by restoring the unique compressed image among the compressed image. In other words, the compressed image is corrected by using the raster image of the designated reusable object based on the layout information contained in the printing data. This eliminates the need to generate the raster image of the entire page. Moreover, it prevents the peripheral image of the object that corresponds to the unique area from getting lost, thus making it possible to correct more accurately.

Therefore, the second embodiment makes it possible, in addition to the effect of the first embodiment, to reduce the RIP time by reusing the raster image generated by applying RIP to the reusable object, thus improving the printing process performance further.

Next, a printing system according to the third embodiment of the invention will be described below. Since the hardware constitution is identical to that of the printing system of the first embodiment, the description is omitted. The following description of the printing system according to the third embodiment therefore focuses on those points which are different from the first embodiment.

In the first embodiment, the printing data is generated using the variable language and the updated block information is based on the layout information. The third embodiment provides the method of generating the updated block information even when the printing data is generated without using the variable language.

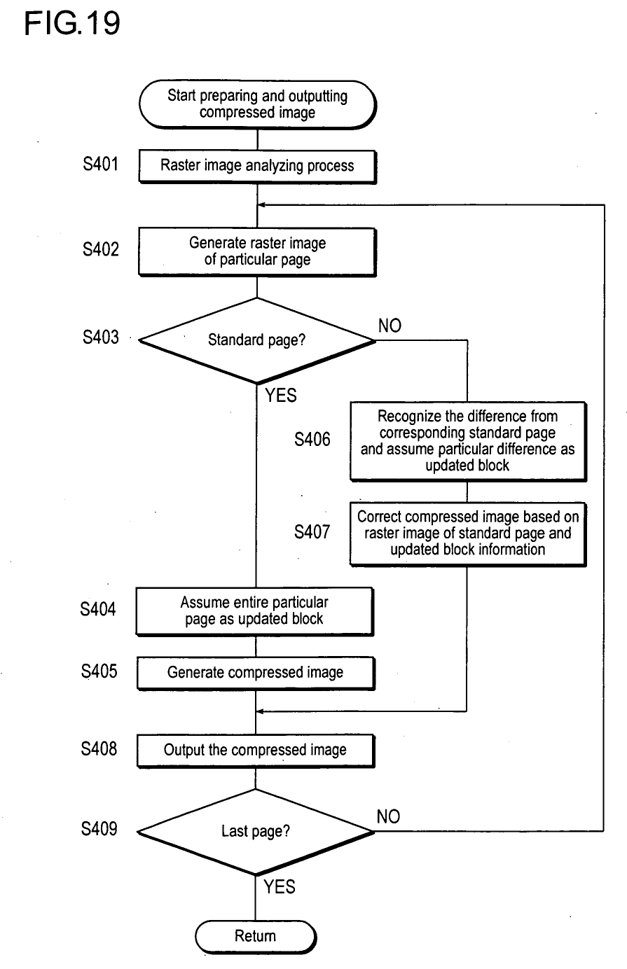

FIG. 19 is a flowchart indicating the process sequence of preparing and outputting the compressed image in a third embodiment.

First, the raster image analyzing process will be performed (S401). In the raster image analyzing process, the image data contained in the printing data are divided into equal parts within each page and the equally divided parts are compared among various pages in order to identify the common areas that are commonly used in a plurality of pages from the unique areas that do not belong to the common areas. The image data used here is the bitmap-formatted image data converted to have a resolution lower than that of the bitmap-formatted image data used for printing.

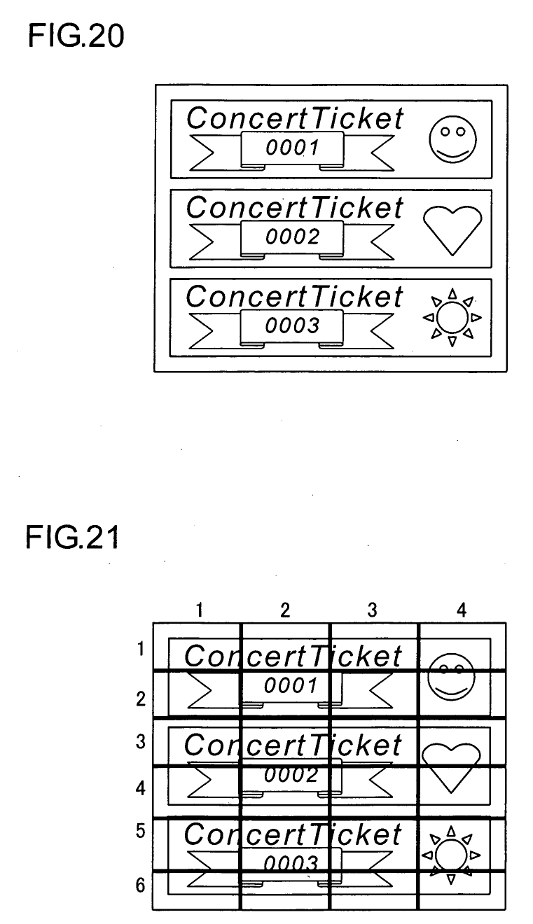

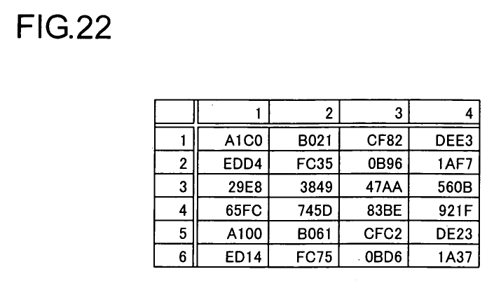

FIG. 20 is a drawing to show an example RGB raster image generated with a low degree of resolution. The RGB raster image of a low degree of resolution is generate here in order to minimize the generating time and the analyzing time. The generated RGB raster image is equally divided into M (rows)×N (columns) as shown in FIG. 21. In FIG. 21, the RGB raster image is divided into six rows and four columns. It is preferable to divide the RGB raster image equally in a lattice pattern within one page from the standpoint of an efficient process. This provides a particularly efficient process in case of data that the majority of images are common among a plurality of pages and only a small portion of images are different. The dividing numbers M×N are arbitrary and preset. The area in which the image data is equally divided within the page preferably corresponds to the block to which the compression process is applied. Later, each of these equally divided areas is quantified. In other words, the hash value for each area is calculated using the hash function and entering the pixel values of the RGB color components in each area as the input. FIG. 22 shows an example table of hash values of various areas in the RGB raster image of a single page. The hash function can be, for example, MD 5 (Message Digest 5) or SHA (Secure Hash Algorithm). The range of the pixel value is typically R (red)=0-255, G (green)=0-255, and B (Blue)=0-255. The above process is repeated until the process for the entire page ends.

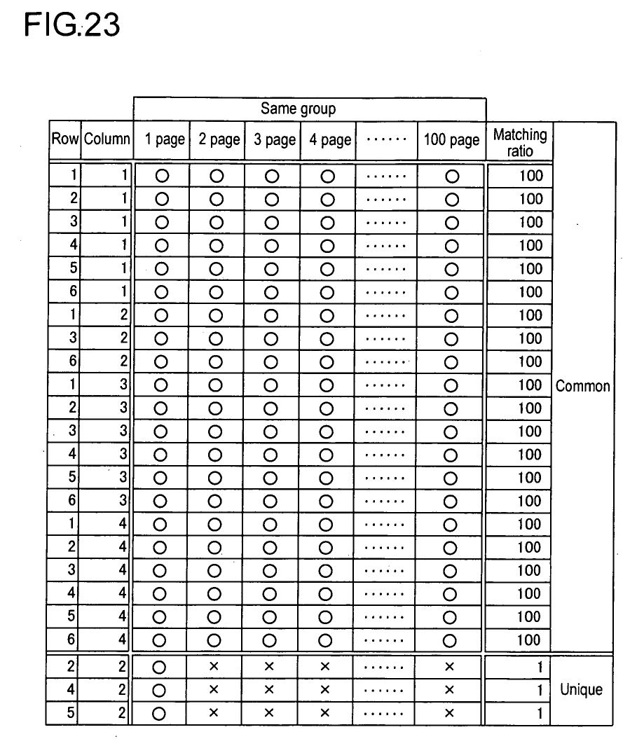

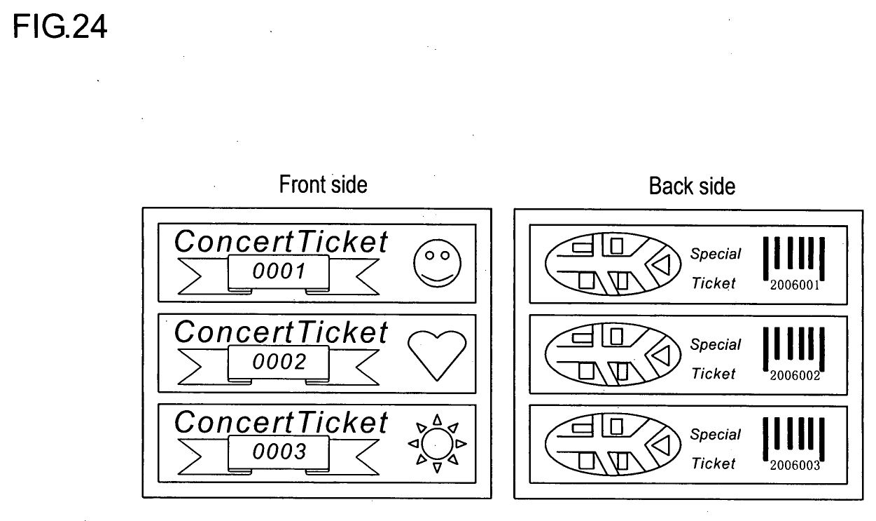

When the process of all the pages is finished, the similarity between pages is judged to classify them into groups. Next, the common areas and the unique areas are extracted for each group. Specifically, the matching ratio is calculated for each area (row 1/column 1, row 2/column 1, . . . row 6/column 4). The matching ratio of each area is the ratio of the number of pages, in which the value of a particular area matches with the value of the corresponding area of the standard page, relative to the total number of pages. The areas, of which the matching ratios are 100%, are the common areas and other areas are the unique areas (refer to FIG. 23). The equally divided areas are compared with each other between pages based on the data obtained by quantification of those areas. Thus, a quick and accurate comparison between the areas is made possible. FIG. 24 is a diagram showing an example of generated low resolution RGB raster image in case when the printing data having a front page and a back page is to be printed on both sides. In this case, two groups are formed so that the standard page is the top page (first page) and the second page.

Next, the printing data stored in the hard disk 24 is transferred to the raster image generating part 211 where one page portion of the raster image is generated (S402). The raster image generated here is the image data of the bitmap type of the resolution used in printing.

Next, a judgment is made as to whether the generated raster image is that of the standard page or not (S403). The standard page here means the smallest page of a group classified based on the similarity among the pages.

If the generated raster image is a standard page (S403: Yes), the printing data analyzing part 212 generates the updating block information, of which the entire particular page is the updating block (S404).

Next, a compression process is applied to the raster image of the standard page to generate a compressed image (S405), and the program proceeds to step S408. The compressed image thus generated is remembered in the compressed image storage part 233. The compressed images as many as the number of the standard page will be stored individually.

On the other hand, if the generated raster image is not the standard page (S403: No), the difference between the raster image of the page in question and that of the corresponding standard page as the unique area based on the result of the raster image analyzing process in step S401, and generates the updated block information using said difference as the updating block (S406).

Next, the compressed image stored in the corrected image storage part 233 is corrected based on the corresponding standard page's raster image and the updated block information (S407).

In step S408, the compressed image generated in step S405 or the compressed image corrected in step S407 are outputted to the printer 3A. The printer 3A restores (expands) and prints the compressed image received from the printer controller 2A on a recording medium such as a sheet of paper.

In step S409, a judgment is made as to whether the page currently being processed is the final page or not. If it is judged that it is no the final page (S409: No), the program returns to step S402. If it is judged that it is the final page (S4090: Yes), the program returns to the flowchart of FIG. 11.

As can be seen from the above, the printer controller of the third embodiment divides the image data into a plurality of equally divided areas within a page, and identifies an area as a unique area if the area has different contents when a plurality of areas within said particular page are compared with a plurality of areas of a page different from said particular page respectively between the corresponding areas.

Therefore, in the third embodiment, the updated block information can be generated even when the printing data is generated without using the variable language achieving an effect similar to that of the first embodiment. Thus, the areas sharing the same common contents among a plurality of pages of the compressed images are reused, and only the areas that need to be updated are updated. Thus, the time required for the process of compressing the image data consisting of a plurality of pages can be reduced and the printing process performance can be improved.

Moreover, in the third embodiment, it is conceivable that the received printing data is described using the general purpose PDL. However, this embodiment is applicable even to a case in which the printing data is the RIP-processed page image data. The page image data to which RIP has been applied includes multi-page TIFF images, images generated by GDI driver, bitmap images, and JPEG images.

It is obvious that this invention is not limited to the particular embodiments shown and described above but may be variously changed and modified without departing from the technical concept of this invention.

Although the invention is described in the above embodiments for a case where the printer controller as the image processing device and the printer as the image forming device are installed independently, the printer controller can be installed in the printer.

Also, although the embodiments described above uses a printer as the image forming apparatus, the invention is not limited to it. The present invention is applicable to an image forming apparatus such as MFP (Multi-Function Peripheral) and a copying machine as well.

The means and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the image processing apparatus as a part of its function.

What is claimed is:

1. An image processing apparatus, comprising:
a compression unit that applies a compression process to each of a plurality of areas within a page independently on a specified page of image data consisting of a plurality of pages;
a storage unit that stores the compressed image data of said specified page obtained by the compression by said compression unit;
an identifying unit that identifies an area as a unique area if the area has different contents when a plurality of areas within said specified page are compared with a plurality of areas within a page different from said specified page respectively between the corresponding areas;
a correction unit that corrects unique compressed image data among compressed image data of said specified page stored in said storage unit that corresponds to said unique area to be identical to corrected unique compressed image data obtained by compressing said unique area of a page different from said specified page; and
an output unit that outputs the compressed image data corrected by said correction unit.

2. The image processing apparatus as claimed in claim 1, wherein
each page of said image data is obtained by converting each page of printing data inputted into said image processing apparatus into data of a bitmap format used for printing; and
said identification unit identifies said unique area based on layout information contained in said printing data that indicates which object to be laid out where in the page.

3. The image processing apparatus as claimed in claim 1, wherein
the specified page of said image data is obtained by converting said specified page of printing data inputted into said image processing apparatus into data of a bitmap format used for printing; and
said identification unit identifies said unique area based on layout information contained in said printing data that indicates which object to be laid out where in the page; and
said corrected unique compressed image data is the image data obtained by applying the compression process to the image data, which is obtained by overwriting the restored image data of said unique compressed image data with the object image data obtained by converting the objects corresponding to said unique areas of said printing data into data of a bitmap format used for printing.

4. The image processing apparatus as claimed in claim 1, wherein
said identifying unit divides said image data into a plurality of equally divided area within a page, and identifies an area as a unique area if the area has different contents when a plurality of areas divided within said specified page are compared with a plurality of areas of a page different from said specified page respectively between the corresponding areas.

5. The image processing apparatus as claimed in claim 4, wherein
said corresponding areas are compared based on the data obtained by digitizing each area.

6. The image processing apparatus as claimed in claim 1, wherein
said compression process is a fixed length data compression process.

7. A computer readable recording medium stored with an image processing program, said image processing program causing a computer to execute a process comprising:
1) applying a compression process to each of a plurality of areas within a page independently on a specified page of image data consisting of a plurality of pages;
2) storing the compressed image data of said specified page obtained by the compression in said step 1) in a storage unit; 3) identifying an area as a unique area if the area has different contents when a plurality of areas within said specified page are compared with a plurality of areas within a page different from said specified page respectively between the corresponding areas;
4) correcting unique compressed image data among compressed image data of said specified page stored in said storage unit that corresponds to said unique area to be identical to corrected unique compressed image data obtained by compressing said unique area of a page different from said specified page; and
5) outputting the compressed image data after the correction in said step 4).

8. The computer readable recording medium stored with an image processing program as claimed in claim 7, wherein
each page of said image data is obtained by converting each page of printing data inputted into said image processing apparatus into data of a bitmap format used for printing; and
in said step 3), said unique area is identified based on layout information contained in said printing data that indicates which object to be laid out where in the page.

9. The computer readable recording medium as claimed in claim 7, wherein
the specified page of said image data is obtained by converting said specified page of printing data inputted into said image processing apparatus into data of a bitmap format used for printing; and
in said step 3), said unique area is identified based on layout information contained in said printing data that indicates which object to be laid out where in the page; and
said corrected unique compressed image data is the image data obtained by applying the compression process to the image data, which is obtained by overwriting the restored image data of said unique compressed image data with the object image data obtained by converting the objects corresponding to said unique areas of said printing data into data of a bitmap format used for printing.

10. The computer readable recording medium as claimed in claim 7, wherein
in said step 3), said image data is divided into a plurality of equally divided area within a page, and an area is identified as a unique area if the area has different contents when a plurality of areas within said specified page are compared with a plurality of areas of a page different from said specified page respectively between the corresponding areas.

11. The computer readable recording medium as claimed in claim 10, wherein
said corresponding areas are compared based on the data obtained by digitizing each area.

12. The computer readable recording medium as claimed in claim 7, wherein
said compression process is a fixed length data compression process.

13. An image processing method, comprising:
1) applying a compression process to each of a plurality of areas within a page independently on a specified page of image data consisting of a plurality of pages;
2) storing the compressed image data of said specified page obtained by the compression in said step 1) in a storage unit; 3) identifying an area as a unique area if the area has different contents when a plurality of areas within said specified page are compared with a plurality of areas within a page different from said specified page respectively between the corresponding areas;
4) correcting unique compressed image data among compressed image data of said specified page stored in said storage unit that corresponds to said unique area to be identical to corrected unique compressed image data obtained by compressing said unique area of a page different from said specified page; and
5) outputting the compressed image data after the correction in said step 4).
